(19) United States
(12) Patent Application Publication
(10) Pub. No.: US 2021/0252481 A1
(43) Pub. Date: Aug. 19, 2021

(54) PELLETS OF SORBENT SUITABLE FOR CARBON DIOXIDE CAPTURE

(71) Applicant: AMTECH AS, Bergen (NO)

(72) Inventors: De Chen, Bergen (NO); Li He, Bergen (NO); Kumar Rout, Bergen (NO); Edd Blekkan, Bergen (NO); Asbjorn Strand, Bergen (NO)

(73) Assignee: AMTECH AS, Bergen (NO)

(21) Appl. No.: 17/256,629

(22) PCT Filed: Jun. 27, 2019
(86) PCT No.: PCT/EP2019/067225

§ 371 Date: Dec. 28, 2020

(30) Foreign Application Priority Data
Jun. 28, 2018 (GB) 1810620.3

(51) Int. Cl. B01J 20/30; B01D 53/02; B01D 53/62; B01D 53/81; B01J 20/02; B01J 20/04; B01D 53/52

(52) U.S. Cl. CPC B01J 20/3078; B01D 2257/504; B01D 53/02; B01D 53/62; B01D 53/81; B01J 20/0248; B01J 20/043; B01J 20/0211; B01J 20/0207; B01D 53/523; B01D 2251/402; B01D 2251/404; B01D 2256/16; B01D 2251/602; B01D 2257/302; B01D 2257/304; B01J 20/3028

(57) ABSTRACT

The present invention relates to methods for the preparation of pellets of sorbent suitable for carbon dioxide capture, to said pellets of sorbent, and to the use of said pellets of sorbent in carbon dioxide capture.

### FIELD OF THE INVENTION

The present invention relates to methods for the preparation of pellets of sorbent suitable for carbon dioxide capture, to said pellets of sorbent, and to the use of said pellets of sorbent in carbon dioxide capture.

### BACKGROUND TO THE INVENTION

Carbon capture and storage is a process of capturing waste carbon dioxide from a source, such as a fossil fuel power plant, and then transporting and depositing it such that it will not enter the atmosphere. The primary purpose of carbon capture and storage is to reduce the amount of carbon dioxide released into the atmosphere, and thereby mitigate environmental problems associated with carbon dioxide, such as global warming and ocean acidification.

For large-scale post-combustion carbon dioxide capture, chemical solvent processes represented by amine processes are regarded as the most commercially-feasible technology. As of 2018 the only commercial-scale carbon dioxide capture plant in operation for decarbonising a power plant was the amine process in the Boundary Dam carbon capture storage project in Canada. However, integrating an amine capture plant with a power plant requires a great deal of low pressure steam to be extracted from the steam cycle for solvent regeneration. That steam would otherwise be used for power generation, and results in an energy penalty of about 8%. This energy penalty, combined with the additional capital expenditure, has deterred commercialisation of carbon capture and storage so far. For these reasons, it would be desirable to develop alternative capture processes with higher economic feasibility than conventional amine processes.

CaO-based sorbents can in principle overcome many of the problems associated with conventional amine processes. Dolomite (primary components calcium carbonate and magnesium carbonate) and limestone (primary component calcium carbonate) are abundant and cheap natural materials, which can be calcined to provide CaO-based sorbents. However, it has been observed that sorbents prepared from dolomite and limestone exhibit a rapid loss of CO₂ capture capacity during the first few carbonation/decarbonation cycles and subsequently retain only a limited CO₂ capture capacity.

A number of different techniques have been investigated for reducing the loss of CO₂ capture capacity of dolomite and limestone, including (a) thermal/hydration treatments prior to/during the cycle of carbonation/decarbonation, (b) reduction of the size of CaO crystallites, (c) adding foreign material to the limestone or dolomite starting materials, and (d) synthesis of CaO-based sorbents from organic or inorganic precursors to CaO and dopants.

In general, strategies (a) and (b) have been found ineffective. A possible reason for this is that the stability of the sorbents prepared according to strategies (a) and (b) may be limited, at least to some extent, by the stability of the starting material (i.e. limestone or dolomite). Strategies (c) and (d) are therefore considered more promising. However, whilst strategy (d) has been reported potentially to provide CaO-based sorbents with high reactivity, these techniques are generally considered too expensive for providing sorbents in the quantities required for commercial-scale processes.

Strategy (c), namely adding foreign material to the limestone or dolomite starting materials, has the potential provide sorbents cheaply, due to the low cost of the starting materials. To date, though, it has not been possible to prepare sorbents with the desired properties using this strategy.

For example, an attempt was made to improve the capture performance of natural dolomite by doping nano-particles of refractory material in B. Arstad, A. Spjelkavik, K. A. Andreassen, A. Lind, J. Prostak, R. Blom, Studies of Ca-based high temperature sorbents for carbon dioxide capture, Enrgy Proced, 37 (2013) 9-15. CaTiO₃, CaZrO₃, and CaAl₂O₄ were doped on calcined dolomite solid. However, none of the doped dolomites showed superior performance as compared with the original dolomite. The best doped dolomite was only able to capture less than 0.05 g_{CO2}/g_{sorbent} after 30 cycles of carbonation at 600° C. in 10 vol % carbon dioxide and calcination at 850° C. in N₂.

In addition, many of the sorbents prepared to date have been in the form of powders. However, powders are difficult to handle, and cannot easily be controlled in a fluidized-bed type reactor. Pellets, for example spherical or cylindrical pellets, of sorbents are preferable from the perspective of increased the flowability and reduced attrition losses in a fluidized-bed type reactor.

In summary, there remains a need for new sorbents that avoid the energy penalty associated with amine processes. The new sorbents would need have a high CO₂ capture capacity, and to retain an acceptable level of CO₂ capture capacity following multiple cycles of carbonation/decarbonation. In addition to these CO₂ capture performance requirements, the sorbent would ideally be prepared from low cost materials and take the form of pellets.

A new sorbent, which has excellent CO₂ capture performance, is in the form of pellets and is manufacture from low cost materials, could potentially provide an economically viable alternative to amine processes in commercial-scale carbon dioxide capture plants.

### SUMMARY OF THE INVENTION

It is a finding of the present invention that it is possible to prepare pellets of sorbent with excellent CO₂ capture performance from dolomite, which is a naturally occurring and low cost material, by adding sources of at least two different metal ions during the preparation of the pellets of sorbent from the dolomite. The resulting pellets of sorbent have a high CO₂ capture capacity, and retain an acceptable level of CO₂ capture capacity following multiple cycles of carbonation/decarbonation. It is believed that the combination of the two different metal ions provides the excellent CO₂ capture performance observed over multiple cycles. The pellets of sorbent can be conveniently produced using a one-pot process, and are environmentally friendly.

Accordingly, the present invention provides a method for preparing pellets of sorbent suitable for carbon dioxide capture, the method comprising:

(a) calcining a starting material comprising dolomite to obtain a base material;

(b) mixing the base material with water and additives, wherein the additives comprise a first additive and a second additive, and processing the resulting mixture to provide intermediate pellets; and

(c) calcining the intermediate pellets to provide the pellets of sorbent, wherein:

the first additive is a source of first metal ions, which first metal ions are ions of Al or Mg, and

the second additive is a source of second metal ions, which second metal ion are ions of Al, Mg, a transition metal or a lanthanide, and

the first and second metal ions are not both ions of Al or both ions of Mg.

The present invention further provides:
pellets of sorbent suitable for carbon dioxide capture, which pellets are obtainable by the above method;
a sorbent suitable for carbon dioxide capture, which sorbent comprise CaO, MgO, 0.5 to 20 wt % of first metal ions and 0.5 to 10 wt % of second metal ions, wherein the first metal and second metal ions as defined above, and wherein the sorbent is preferably in the form of power or pellets, more preferably pellets;
a method for carbon dioxide capture, which method comprises exposing sorbent as defined above to carbon dioxide under conditions suitable for carbon dioxide capture, thereby providing a carbonated sorbent comprising the captured carbon dioxide;
carbonated sorbent, which carbonated sorbent comprises carbonated CaO, MgO, 0.4 to 20 wt % of first metal ions and 0.4 to 10 wt % of second metal ions, wherein the first metal and second metal ions are as defined above, and wherein the sorbent is preferably in the form of power or pellets, more preferably pellets; and
use a sorbent as defined above, for: carbon dioxide capture, preferably (a) post-combustion carbon dioxide capture, or (b) pre-combustion carbon dioxide capture from a H₂ and CO₂-rich gas mixture; or capture of sulfur-containing compounds, preferably capture of SO₂ and/or H₂S, from sour gas.

### BRIEF DESCRIPTION OF THE DRAWINGS

FIG. 1A is a flow chart summarising the various stages of the methods used in the present invention to prepare pellets of sorbent, as described herein. FIG. 1B is a flow chart summarising an alternative method to prepare the sorbent in powder form. FIG. 1C is a further flow chart showing an exemplary method for preparing pellets of sorbent according to the invention.

FIGS. 2A and 2B shows the properties of base material as function of time and temperature following calcination of raw dolomite as a starting material in Example 1.

FIG. 3 provides a comparison of carbon dioxide capture capacity of sorbent prepared by one-pot processing with sample prepared by separated mixing, under the cycles of wet carbonation and regeneration, as described in Examples 2 and 3. The samples (i.e. One-pot No 18-5 and WM No 18-5) are derived from dolomite loaded with same primary and secondary additives and have the same quantities of Al and Zr oxides in final sorbent. The wet test conditions are described in Example 3.

FIG. 4A shows conversion in long-cyclic test (over 120 cycles) with for various sorbent compositions, as described in Examples 6 to 8.

FIG. 4B shows conversion in long-cyclic test (over 200 cycles) with various sorbent compositions, as described in Example 6

FIG. 5 shows dry carbonation test results of one-pot pellets for starting material screening, as described in Example 9.

FIG. 6 shows a comparison of carbon dioxide capture stability of sample No 8-6 under wet and dry conditions for carbonation, as described in Examples 10 and 11.

FIG. 7 shows a comparison of carbon dioxide capture stability of sample No 8-12 under wet and dry conditions for carbonation, as described in Examples 10 and 11.

FIG. 8 shows the effect of various combination of the additives (Al—Zr) on capture performance of the sorbent pellets under wet carbonation conditions, as described in Example 11.

FIG. 9 shows the effect of various combination of the additives (Mg—Zr and Mg—Ce) on capture performance of sorbent pellets under wet carbonation condition, as described in Example 11.

FIG. 10 shows the effect of various combination of the additives (Al—Mg and Al—Ce) on capture performance of sorbent pellets under wet carbonation condition, as described in Example 11.

FIG. 11 provides a comparison of carbon dioxide capture performance of products prepared on two different scales. Samples No 8-12_M and No 8-12 were prepared on scales of 100-400 g and 20-30 g, respectively, as described in Example 12.

FIG. 12 shows the results of the results of falling tests on pellets sized at 850-500 μm, as described in Example 13.

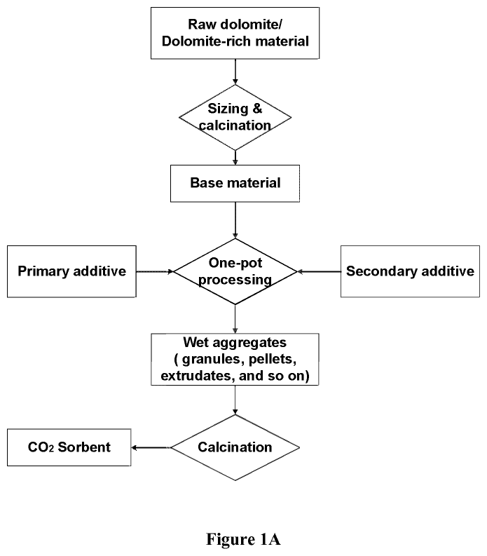

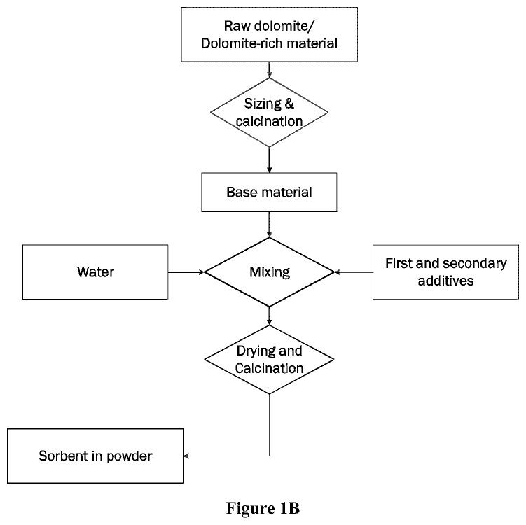

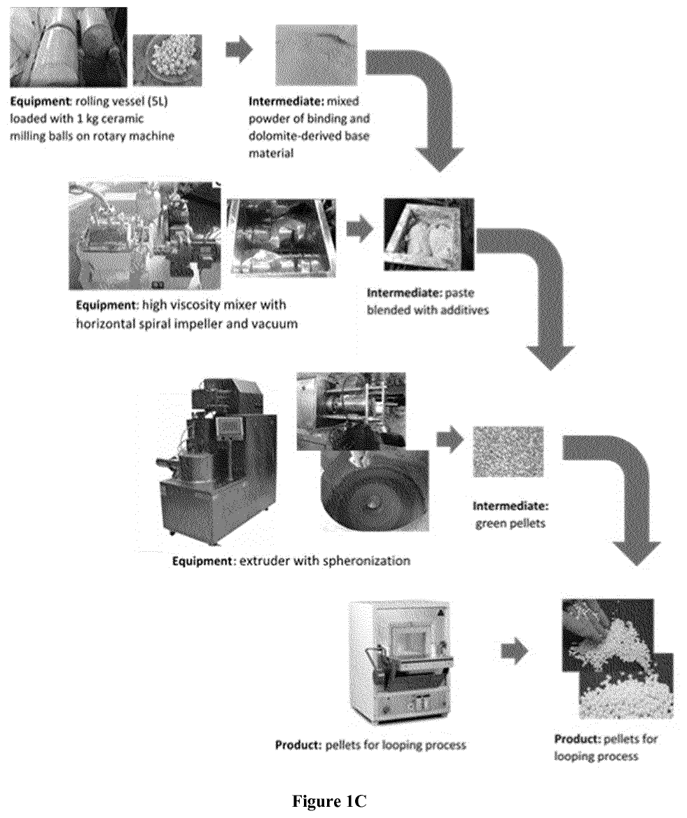

### DETAILED DESCRIPTION OF THE INVENTION

The present invention is concerned with the preparation of pellets of sorbent suitable for carbon dioxide capture. The methods described herein comprise the following steps:

(a) calcining a starting material comprising dolomite to obtain a base material;

(b) mixing the base material with water and additives, wherein the additives comprise a first additive as herein defined and a second additive as herein defined, and processing the resulting mixture to provide intermediate pellets; and

(c) calcining the intermediate pellets to provide the pellets of sorbent.

The starting material used in step (a) comprises dolomite. Dolomite is a naturally-occurring calcium magnesium carbonate mineral. Dolomite is anhydrous. The formula of calcium magnesium carbonate is CaMg(CO₃)₂, which can also be written as CaCO₃.MgCO₃.

Typically, the starting material comprises at least 80 wt % of CaMg(CO₃)₂, preferably at least 90 wt % of CaMg(CO₃)₂, more preferably at least 95 wt % of CaMg(CO₃)₂. The starting material may consist, or consist essentially, of CaMg(CO₃)₂.

Given that dolomite is a naturally occurring-mineral, it may comprise, in addition to calcium magnesium carbonate, trace amounts of other compounds, such as small quantities of oxides of metal such as aluminium, zinc, iron, silicon, potassium, sodium and the like. The presence/absence of these small amounts of other compounds is not considered to have a significant effect on the properties of the pellets of sorbent.

Prior to the calcination of step (a), preparation of the as-received dolomite may be required in order to place it in a form suitable for calcination. A skilled person can easily assess whether such preparation, for example crushing typically followed by sieving, is required. Sieving allows for particles in the desired size range to be selected.

It is generally desirable for the starting material to have a maximum particle size of less than 210 μm. Thus, typically the maximum particle size of the starting material (generally after crushing and sieving) is less than 210 μm, preferably less than 105 μm.

Typically the average particle size of the starting material is from 70 to 120 μm, preferably 20 to 70 μm. Average particle size is generally measured by laser diffraction particle size analysis. More preferably the maximum particle size of the starting material is less than 210 μm and the average particle size is from 70 to 120 μm. Most preferably the maximum particle size of the starting material is less than 105 μm and the average particle size is 20 to 70 μm.

The starting material then undergoes calcination in step (a). Calcination is a well-known technique, which involves heating to high temperatures in an inert gas (e.g. nitrogen), air or oxygen. In the present invention, typically air or oxygen is used, preferably air. Calcination of the starting material in step (a) at least partially converts the CaMg(CO₃)₂ in the starting material to the corresponding metal oxides. There are two separate decomposition reactions that occur: the decomposition of MgCO₃ to MgO (i.e. Equation 1) generally takes place at a lower temperature and more rapidly than the decomposition of CaCO₃ to CaO (Equation 2).

CaCO₃.MgCO₃→CaCO₃.MgO+CO₂ Equation 1:

CaCO₃.MgO→CaO.MgO+CO₂ Equation 2:

It is believed that the relatively rapid decomposition of MgCO₃ initially according to Equation 1 promotes formations of pores and thereby provides a material with a high surface area.

If the starting material is fully calcined, then there is 100% conversion of CaMg(CO₃)₂ to CaO and MgO. If the starting material is partially calcined, then a mixture of CaCO₃, MgO and/or CaO is formed.

The calcination temperature used in step (a) is typically 700 to 1200° C., preferably 800 to 900° C. The duration of calcination in step (a) is typically 2 to 12 hours. Preferably the calcination temperature used in step (a) is 800 to 900° C., and the duration of calcination is 3 to 6 hours. By using these conditions, at least partial conversion of the CaMg(CO₃)₂ in the starting material to the corresponding metal oxides is achieved (i.e. the starting material is at least partially calcined).

Following the calcination in step (a), a base material is obtained. Depending on the physical form of the starting material, the base material may need to be crushed to small-sized particles and sieved to obtain a desirable size range. Sieving allows for particles in the desired size range to be selected. It is generally desirable for the base material to have a maximum particle size of less than 210 μm. Thus, typically the maximum particle size of the base material is less than 210 μm, preferably less than 105 μm. Typically the average particle size of the base material is from 70 to 120 μm, preferably 20 to 70 μm. Average particle size is generally measured by laser diffraction particle size analysis. More preferably the maximum particle size of the base material is less than 210 μm and the average particle size is from 70 to 120 μm. Most preferably the maximum particle size of the base material is less than 105 μm and the average particle size is 20 to 70 μm.

Typically, the base material obtained from step (a) is porous. Preferably, the base material obtained from step (a) has a surface area of from 0.5 to 100 m²/g, preferably from 2 to 40 m²/g. Surface area, can be measured using any routine technique known to those of skill in the art, for instance, Brunauer-Emmett-Teller (BET) surface area analysis. As mentioned above, it is believed that the decomposition of MgCO₃ according to Equation 1 above contributes to formation of a base material with the desired porosity and/or surface area.

Generally, the base material obtained from step (a) will be cooled, for example to room temperature, prior to step (b). There is generally no requirement for any other intervening processing steps. However, if the base material from step (a) is stored prior to step (b), then the CaO and MgO in the base material might form hydrates (i.e. Ca(OH)₂ and Mg(OH)₂) if exposed to moisture. Typically, if the base material has been stored/exposed to water such that hydrates may have formed, then the water will be removed from the base material prior to step (b). Removal of the water may be carried out by any suitable technique, but typically heating is used.

In step (b), the base material is mixed with water and additives, wherein the additives comprises a first additive and a second additive, and the resulting mixture is processed to provide intermediate pellets.

Typically, the mixing and processing of step (b) are carried out in the same container. Step (b) is thus typically a “one-pot process”. One-pot processing is desirable because the number of material handling steps is decreased and the procedure for preparing the pellets of sorbent is simplified. In addition, one-pot processing has potential to increase the overall production repeatability by lowering risk of material contamination. Further, the total production time from the raw materials to the pellets of sorbent can be reduced while maintaining a high yield and keeping production support to a minimum. One-pot processing as described herein, together with the other features of the claimed methods, can potentially be scaled-up for medium- or large-scale production for commercial purposes, whilst retaining the desirable properties of the resulting pellets of sorbent.

The mixing and processing can be carried out simultaneously or sequentially (i.e. mixing then processing). However, it is preferred that the mixing and processing are carried out simultaneously, that is to say the act of mixing the base material, water and additives also processes the resulting mixture to form the desired intermediate pellets.

The mixing and processing of step (b) are typically carried out for 5 minutes to 10 hours, preferably for 20 minutes to 4 hours.

The mixing and/or processing of step (b) are typically conducted by one or more of (i) shear force supplied by a manual or motor-driven impellor, (ii) centrifugal force supplied by a rotary container, (iii) extrusion force, and (iv) agitation forced by flowing gas. Preferably, impellor, centrifugal force and/or extrusion force are used.

The intermediate pellets formed in step (b) are typically substantially spherical, substantially cylindrical or are in honeycomb form. Substantially cylindrical pellets may be hollow. Substantially spherical and substantially cylindrical intermediate pellets are preferred, with substantially spherical intermediate pellets particularly preferred.

The largest dimension of the pellets is typically in the range 50 to 6000 μm, preferably 300 to 3000 μm, more preferably 500 to 3000 μm, most preferably 700 to 3000 μm.

Thus, when the intermediate pellets are substantially spherical, the pellets typically have diameters of 50 to 6000 μm, preferably 300 to 3000 μm, more preferably 500 to 3000 μm, most preferably 700 to 3000 μm. The pellet diameters are measured by sieving, which allows for pellets within these ranges to be selected.

When the intermediate pellets are substantially cylindrical, the diameter of the circular cross section of the pellets is typically 500 to 5000 μm or 300 to 3000 μm, preferably 500 to 3000 μm, more preferably 700 to 3000 μm, most preferably 850 to 3000 μm. Cylindrical pellets are typically prepared by extrusion, and thus the diameter of the pellet is determined by the hole size of the extrusion plate.

When the intermediate pellets are in honeycomb form, typically they have a wall thickness of 500 to 5000 μm or 300 to 3000 μm, preferably 500 to 3000 μm, more preferably 700 to 3000 μm, most preferably 850 to 3000 μm. Honeycomb form is typically prepared by extrusion, such that the wall thickness is determined by the template plate used during the extrusion.

The first and second additives in step (b) can be added as solid or dissolved in an aqueous solvent. The first and second additives can be added sequentially in any order or simultaneously.

Typically, water-soluble additives are added dissolved in aqueous solvents. The aqueous solvent is preferably water (i.e. water with no other solvent). If both the first additive and the second additive are water-soluble, they can be added dissolved in the same aqueous solvent, or they can be dissolved in separate aqueous solvents and then added sequentially or simultaneously.

Typically, non-water-soluble additives are added as solids. If both the first additive and the second additive are non-water-soluble, they can be mixed together as solids prior to addition, or they can be added as separate solids sequentially or simultaneously.

If one additive is water-soluble and another is non-water-soluble, then typically the water soluble additive is added dissolved in an aqueous solvent and the non-water-soluble is added as solid, but it is also possible to add both additives as solids.

The first additive is a source of first metal ions, which first metal ions are ions of Al or Mg, and the second additive is a source of second metal ions, which second metal ion are ions of Al, Mg, a transition metal or a lanthanide. The first and second metal ions are not both ions of Al or both ions of Mg. Typically, the transition metal is Zr. Typically, the lanthanide is Ce.

Thus, it is preferred that:
(i) the first additive is a source of ions of Al and the second additive is a source of ions of Mg,
(ii) the first additive is a source of ions of Al and the second additive is a source of ions of Zr,
(iii) the first additive is a source of ions of Al and the second additive is a source of ions of Ce,
(iv) first additive is a source of ions of Mg and the second additive is a source of ions of Al,
(v) the first additive is a source of ions of Mg and the second additive is a source of ions of Zr, or
(vi) the first additive is a source of ions of Mg and the second additive is a source of ions of Ce.
   The preferred combinations are [first additive-second additive]: Al—Zr, Mg—Zr and Al—Mg, more preferable Al—Zr.

Typically, the source of ions of Al is Al₂O₃, AlCl₃, Al(NO₃)₃, CaAlO₄, or a mixture thereof. CaAlO₄ is conveniently provided by using calcium aluminium cement as an additive. CaAlO₄, particularly in the form of calcium aluminium cement, has been found to provide pellets of sorbent with improved performance. Typically, the source of ions of Mg is MgO, Mg(NO₃)₂, MgCl₂ or a mixture thereof. Typically, the source of ions of Zr is ZrO₂, ZrCl₄, ZrN₂O₇ or a mixture thereof. Typically, the source of ions of Ce is Ce₂O₃, Ce(NO₃)₃, CeCl₃ or a mixture thereof. Preferably, the additive is not a chloride salt, since generally non-chloride salt additives result in pellets of sorbent with improved performance.

The amount of first additive and second additive that is added in step (b) is generally determined based on the desired quantity of first and second metal ion that will be present in the sorbent pellets. Thus, the amount of first additive added in step (b) is typically adjusted such that 0.5 to 20 wt %, preferably 2 to 10 wt %, of the resultant pellets of sorbent is the first metal ions. Similarly, the amount of second additive added in step (b) is typically adjusted such that 0.5 to 10 wt %, preferably 0.5 to 6 wt %, of the resultant pellets of sorbent is the second metal ions. In addition, the relative quantities of first additive and second additive added in step (b) are typically adjusted so that the molar ratio of first metal ions to second metal ions in the resultant pellets of sorbent is from 25 to 0.4, preferably from 10 to 1. A skilled person can easily perform the calculations required to assess how much of each additive should be added in step (b) in view of the amount of base material that is added. For example, a sorbent which has 6.5 wt % of Al and 1 wt % of Zr has a molar ratio of Al to Zr of 22; a sorbent which has 3 wt % of Mg and 2.7 wt % of Ce has a molar ratio of Mg to Ce of 3.

For the avoidance of doubt, it is noted that if the first or second additive is a source of ions of Mg, then the calculation of the wt % Mg in the resultant pellets of sorbent does not include the Mg that is present in the starting material and base material (i.e. the Mg derived from dolomite). Rather, the calculation only takes into account Mg derived from the first or second additive. Similarly, if the starting/base material also contains trace amounts of a metal ion added as a first or second additive in step (b), then the trace amounts of that metal ions are not taken into account when calculating the wt % of that metal ion in the resultant pellets of sorbent. Rather, the calculation only takes into account the metal ions derived from the first or second additive.

Water is added in step (b). The water can be added as a separate component, but it can also be provided at least partially, or entirely, by the addition of a water-soluble first and/or second additive dissolved in an aqueous solvent. Thus, the water can be added (i) entirely as a separate component (when the first and second additives are both solid), (ii) partially as a separate component and partially from the aqueous solvent in which the first and/or second additive is dissolved, or (iii) entirely from the aqueous solvent in which the first and/or second additive is dissolved. Typically, if water is provided partially by the addition of a water-soluble first and/or second additive dissolved in an aqueous solvent, then the addition of the water-soluble first and/or second additive dissolved in an aqueous solvent provides 20 to 90 wt % of the water required.

The water that is added in step (b) hydrates the MgO/CaO present in the base material, which facilitates formation of aggregates and thereby the formation of pellets during mixing and processing. A skilled person can easily determine an appropriate amount to be added for the particular base material and additives being used by routine experimentation.

The mass ratio of the solid material (i.e. the base material and the additive(s) if one or both of them are non-water soluble) to total water, including water from any additives dissolved in an aqueous solvent, is in the range of 4 to 0.2, preferably 2 to 0.5.

Further additives may be added in step (b). When used, the further additives are mixed with the base material, water, first additive and second additive. When used, typically one or more, preferably one to three, for example one or two further additives are added in step (b). Each further additive may (i) be a source of metal ions other than the first metal ions and the second metal ions, for instance, Ti, Si or Fe, or (ii) not contain metal ions. Preferred additives that do not contain metal ions include graphite, organic solvents and polymers. These further additives may act as binding agents. Suitable organic solvents include ethanol, methanol, acetone and ethylene glycol. Suitable polymers are typically those which act as binding agent, and include organic binding agents (such cellulose, flour, starch and dextrin) or boron binding agents (such as colemanite and borax pentahydrate).

The intermediate pellets obtained in step (b) are typically used directly in step (c) without any intervening processing. However, it may in some cases be desirable to subject the intermediate pellets from step (b) to intervening processing prior to step (c). Such intervening processing typically take the form of sieving and/or spheronization.

In step (c), the intermediate pellets are calcined to provide the pellets of sorbent. The calcining in step (c) is typically carried out 700 to 1200° C., preferably at 800 to 1000° C., more preferably 900 to 950° C. The calcining in step (c) is typically carried out for 2 to 12 hours, preferably for 4 to 8 hours, more preferably for 3 to 6 hours. Particularly preferred conditions are 900 to 950° C. for 3 to 6 hours.

The calcination in step (c) removes water and other volatiles from the intermediate pellets. H₂O is removed during the calcination process. When metal nitrates and/or metal chlorides are used as the first or second additive, these generally decompose, typically leading to release of NOx from the nitrates or chlorine-containing gases from the chlorides. The metal ions then generally form metal oxides alone (for example MgO or CeO₂) or react with CaO to form, for instance, CaZrO₃ or CaAl₂O₄.

The pellets of sorbent typically have substantially the same shape and size range as the intermediate pellets. That is to say, the calcination of step (c) does generally not substantially change the shape or size of the intermediate pellets as they are transformed into the pellets of sorbent.

Thus, the pellets of sorbent are typically substantially spherical, substantially cylindrical or are in honeycomb form. Substantially cylindrical pellets may be hollow.

Substantially spherical and substantially cylindrical pellets of sorbent are preferred, with substantially spherical pellets of sorbent particularly preferred.

The largest dimension of the pellets is typically in the range 50 to 6000 μm, preferably 300 to 3000 μm, more preferably 500 to 3000 μm, most preferably 700 to 3000 μm.

Thus, when the pellets are substantially spherical, the pellets typically have diameters of 50 to 6000 μm, preferably 250 to 3000 μm, more preferably 300 to 3000 μm, more preferably 500 to 3000 μm, most preferably 700 to 3000 μm. The pellet diameters are measured by sieving. Pellets of the preferred sizes ranges can be selected by sieving during step (b).

When the pellets of sorbent are substantially cylindrical, the diameter of the circular cross section of the pellets is typically 500 to 5000 μm or 300 to 3000 μm, preferably 500 to 3000 μm, more preferably 700 to 3000 μm, most preferably 850 to 3000 μm. The diameter of the pellet is generally determined by the hole size of the extrusion plate used to form the cylindrical pellets in step (b).

When the intermediate pellets are in honeycomb form, typically they have a wall thickness of 500 to 5000 μm or 300 to 3000 μm, preferably 500 to 3000 μm, more preferably 700 to 3000 μm, most preferably 850 to 3000 μm. Honeycomb form is typically prepared by extrusion, such that the wall thickness is determined by the template plate used during the extrusion to form the honeycomb in step (b).

Typically, 0.5 to 20 wt %, preferably 2 to 10 wt %, of the pellets of sorbent is the first metal ions. Typically, 0.5 to 10 wt %, preferably 0.5 to 6 wt %, of the pellets of sorbent is the second metal ions. The molar ratio of first metal ions to second metal ions in the pellets of sorbent is typically from 20 to 1, preferably from 10 to 2. The first and second metal ions are preferably present in the sorbent pellets in the form of their oxides.

After step (c), the pellets of sorbent can be subjected to further processing. For example, exterior coatings can be added to improve the mechanical strength of the pellets. The present invention thus provides a sorbent which comprises CaO, MgO, 0.5 to 20 wt % of first metal ions and 0.5 to 10 wt % of second metal ions. The first and second metal ions are preferably in the form of their oxides. The sorbent is typically in the form of pellets and is preferably prepared by the methods described above. However, the sorbent may be in the form of a powder. The first and second metals ions are preferably present in the pellets of sorbent in a mass ratio of from 20 to 1, preferably from 10 to 2.

The sorbent, preferably pellets of sorbent, can be used in carbon dioxide capture. A typical method for carbon dioxide capture involves expose the sorbent, preferably pellets of sorbent, to carbon dioxide under conditions suitable for carbon dioxide capture. Typical capture conditions are temperature of 500 to 750° C. in a gas where the concentration of CO₂ is 0.5 vol % to 100%. The carbon dioxide reacts with the sorbent, preferably pellets of sorbent, thereby providing a carbonated sorbent, preferably pellets thereof, comprising the captured carbon dioxide.

The carbonated sorbent, preferably pellets of carbonated sorbent, typically comprise carbonated CaO, MgO, 0.4 to 20 wt % of the first metal ions and 0.4 to 10 wt % of the second metal ions.

In order to subsequently release the captured carbon dioxide, typically carbonated sorbent is calcined, thereby regenerating the original sorbent and releasing carbon dioxide. The carbonated sorbent and original sorbent are preferably in pellet form.

The carbon dioxide capture in which the sorbent may be used is preferably post-combustion carbon dioxide capture. However, the sorbent can also be used for “pre-combustion” carbon dioxide capture from a H₂ and CO₂-rich gas mixture. Such a H₂ and CO₂-rich gas mixture is typically prepared using the water-gas shift reaction, and thereby allows H₂ to be isolated and used as a fuel. The sorbent may also be used for the capture of sulfur-containing compounds, such as SO₂ and/or H₂S, typically from sour gas. In all cases, it is preferred that the sorbent is in the form of pellets.

### EXAMPLES

The following are Examples that illustrate the present invention. However, these Examples are in no way intended to limit the scope of the invention.

### Example 1: Preparation of Base Material

The dolomite mineral (Arctic dolomite) was crushed and sieved to size less than 105 μm. The powdered dolomite was calcined at a temperature in the range of 800° C. to 1000° C. over a period of time in the range from 2 to 12 hours. After calcination, the obtained base material was with increased surface area in the range from 1 to 20 m²/g, preferably in the range from 5 to 15 m²/g.

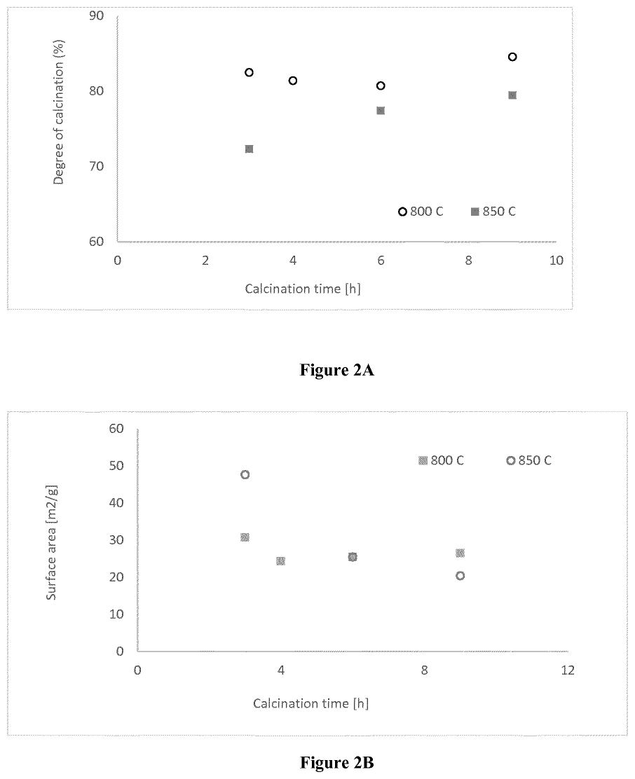

As shown in FIG. 2, for calcination at 800 and 850° C., the calcination degree (gram of reacted CaMg(CO₃)₂/gram of total CaMg(CO₃)₂ in the dolomite) and surface area of the calcined dolomite are a function of calcination time and temperature. A longer calcination time combined with a lower temperature provides the best balance of material properties.

### Example 2: Preparation of Al—Zr Doped Sorbent by Wet Mixing

Aluminium nitrate nonahydrate (9.0 g) was added to water (10 mL). The mixture were heated in a warm bath at temperature of 40° C. to obtain clear solution. The prepared solution was slowly added to the base material dolomite (20 g). ZrN₂O₇ solution (35 wt % in 2.4 mL) was added to the mixture and stirred. The amount of added ZrN₂O₇ solution yielded sorbent as product with molar ratio of active CaO/ZrO at 42:1 by which CaO involved in formation of CaZrO₃ with ZrO₂ is not counted as active CaO. The added aluminium nitrate solution yielded sorbent as product with mole ratio of active CaO/Al₂O₃ at 16:1 by which CaO involved in formation of CaAlO₄ with Al₂O₃ is not counted as active CaO. Accordingly, the sorbent has 1.9 wt % of Zr and 3 wt of Al ions.

The mixture was dried at a temperature of 200′C for 24 hours. The dried mixture was milled to obtained fine powder before granulation or pelletization was conducted. Water (10 mL) was dropped to the fine powder with gentle stirring. Upon addition of water, the agglomeration of the fine powder was initialized

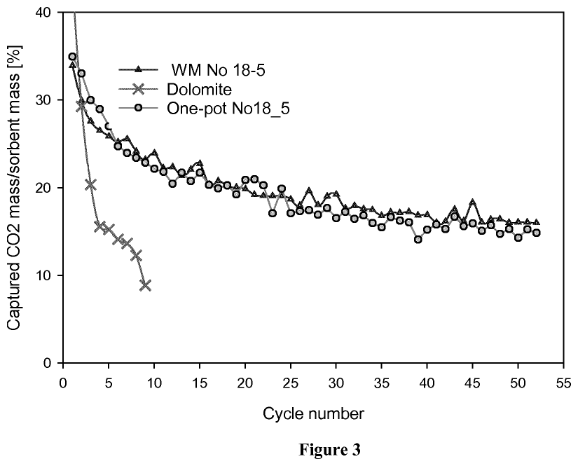

Aggregates with particle sizes in the range of 250 um to 850 μm were dried at ambient temperature and calcined at a temperature of 950° C. for 3 hours. The obtained sorbent (WM No 18_5) was tested under the conditions for wet carbon dioxide capture and the results are shown in FIG. 3. The wet test conditions used for wet CO₂ capture: instrument was a Linseis Thermal Analyzer; aggregates were sized at 500-850 μm or sized at 250-500 μm; sample was loaded at c.a. 15 mg; sorption was carried out as temperature increased from 550° C. to 800° C. with ramp rate at 7.5° C./min at 10 vol % carbon dioxide and 8 vol % steam (balance gas is nitrogen); desorption was carried out as temperature increased from 800° C. to 950° C. with ramp rate at 7.5° C./min at 100% carbon dioxide; temperature dwelled for 10 minutes at 950° C. after the temperature decreased back sorption temperature for another sorption cycle.

### Example 3: One-Pot Processing of Sorbent

Base material (20 g) prepared according to Example 1 was loaded in a granulator and stirred. Aluminium nitrate nonahydrate (9.0 g) was added to water (15 mL) to prepare aluminium solution. 4.0 mL ZrN₂O₇ solution was prepared by adding extra water and diluting 2.4 mL of ZrN₂O₇ solution (35 wt %). The prepared two solutions were energized to form fine droplets and slowly added to the base material in the granulator under stirring.

Extra water was added to the wet solid. The amount of extra water varied from 0 to 10 mL to adjust the size range of the pellets. More added water will increase the overall average size of the pellets while little added water leads to formation of small-size pellets. After the completion of the water addition, the wet solid was continuously stirred and the formed clumps were cut to small aggregates by chopper or manually. Aggregates with particle sizes in the range of 250 μm to 850 μm were selected by sieving and dried at ambient temperature and calcined at a temperature of 950° C. for 3 hours.

The obtained sorbent (No 18-5) was tested under the conditions of wet carbon dioxide capture. The test conditions for wet carbon dioxide capture is as same as described in Example 2. The multi-cycle performance of the sorbent prepared by one-pot method was evaluated and compared with WM No18-5 as prepared in Example 2. WM No18-5 and No 18-5 sorbent pellets have the same metal oxide composition and were prepared with the same starting materials.

FIG. 3 shows the test results with WM No 18-5, No 18-5 and calcined dolomite (prepared by calcination of the base material for 3 hours at 800 and 1000° C., respectively, with no additives used). As seen in FIG. 3, dolomite undergoes a rapid decay of carbon dioxide sorption from over 40% (g_{CO2}/g_{sorbent}) to less than 10% (g_{CO2}/g_{sorbent}) in the first 10 cycles. WM No 18-5 and No 18-5 exhibit capture capacity and stability superior to the calcined dolomite. Similar sorption capacity and capacity variation trend in the cycles are found on the sorbent pellets, suggesting that one-pot method is as effective as separate wet mixing method to prepare sorbent pellets.

Various combination of the primary and secondary additives were used to prepare sorbents by using the above technique.

Table 1 shows the sorbents prepared with a range of combinations of metal oxides derived from the primary and secondary additives.

TABLE 1
sorbents stabilized by mixed oxides of metals derived from
the primary and secondary additives^{a}

| | | Molar ratio of active | | | |
|---|---|---|---|---|---|
| | Metal element | CaO to dopant metal^{b} | | | |
| Name^{d} | (wt %/wt %) | Al₂O₃ | MgO^{c} | CeO₂ | ZrO₂ |
| 4NAl—2NZr | Al (6 wt %)- | 7 | | | 35 |
| | Zr (2 wt %) | | | | |
| 3.5NAl—2Zr | Al (4.5 wt %- | 10 | | | 37 |
| | Zr (2 wt %) | | | | |
| No 8-6 | Al (6.5 wt %)- | 7 (from calcium | | | 42 |
| | Zr (1.9 wt %) | aluminium cement) | | | (from |
| | | | | | ZrCl₄) |
| No 8-6-M | Al (5.9 wt %)- | 8 (from calcium | | | 42 |
| | Zr (1.9 wt %) | cement aluminium) | | | (from |
| | | | | | ZrCl₄) |
| No 8-12 | Al (6.5 wt %)- | 7 (from calcium | | | 40 |
| | Zr (1.9 wt %) | aluminium cement) | | | |
| No 8-12-M | Al (5.9 wt %)- | 8 (from calcium | | | 40 |
| | Zr (1.9 wt %) | aluminium cement) | | | |
| No 18-1 | Al (2.8 wt %)- | 14 | 8 | | |
| | Mg (2.9 wt %) | | | | |
| No 18-2 | Al (2.8 wt %)- | 15 (from calcium | 7 | | |
| | Mg (2.9 wt %) | aluminium cement) | | | |
| No 18-2-M | Al (2.8 wt %)- | 15 (from calcium | 7 | | |
| | Mg (2.9 wt %) | aluminium cement) | | | |
| No 18-3 | Al (2.8 wt %)- | 16 | | 44 | |
| | Ce (1.9 wt %) | | | | |
| No 18-4 | Al (2.8 wt %)- | 17 (from calcium | | 48 | |
| | Ce (1.9 wt %) | aluminium cement) | | | |
| No 18-5 | Al (2.9 wt %)- | 16 | | | 42 |
| | Zr (1.9 wt %) | | | | |
| No 18-6 | Al (2.9 wt %)- | 17 (from calcium | | | 45 |
| | Zr (1.9 wt %) | aluminium cement) | | | |
| No 18-7 | Mg (3 wt %)- | | 15 | 51 | |
| | Ce (2.7 wt %) | | | | |
| No 18-8 | Ce (2.7 wt %) | | | 51 | |

Notes:
^{a}the primary/secondary additive in one-pot processing is a nitrate salt unless it is otherwise specified.
^{b}active CaO is referred to the CaO in the base material which is not involved in the reaction with additives and active to carbon dioxide capture to form CaCO₃. For instance, the amount of active CaO in the base material shall be deducted due to formation of CaZrO₃ or CaAl₂O₄ as inert component to carbon dioxide capture.
^{c}only Mg from the additive is counted in the ratio of active CaO to MgO.
^{d}the samples with M in the name are prepared by one-pot method in rotary drum.

### Example 4: One-Pot Processing by Shear Granulation

The granulator equipped with mixer and chopper was applied to facilitate one-pot processing. Base material (200 g) prepared according to Example 1 and calcium aluminium cement (in the range of 0-60 g) were loaded in the granulator and stirred with the mixer at a speed of 30-50 rpm. ZrN₂O₇ solution was prepared at concentration in the range of 5-20 wt %. The prepared solution (80 mL) was energized to form fine droplets and slowly added to the solid material in the granulator. The rotation speed of the mixer was set in a range of 30 to 100 rpm. Water in the range from 1 to 40 mL, preferably 5 to 20 mL, was added to the wet solid mixture.

After the completion of the water addition, the wet solid was continuously stirred by the mixer at speed of 20 to 200 rpm and the formed clumps were cut to small aggregates by the chopper at speed of 300 to 1500 rpm. The aggregates with the particle size in the range of 250 um to 850 um were dried at ambient temperature and calcined at a temperature of 950° C. for 3 hours.

### Example 5: One Pot Processing by Rotary Drum

The rotary drum equipped with scrubber was applied to facilitate one-pot processing. Base material (200 g) prepared according to Example 1 and calcium aluminium cement at 41 g were loaded in the drum. The rotation speed of the drum was set in the range from 20 rpm. The scrubber removed the solid from the wall of the drum to avoid the accumulation of the solid mass on the wall. ZrN₂O₇ solution was prepared at concentration of 0.15 g/mL. The prepared solution (70 mL) was energized to form fine droplets and slowly added to the solid material in the drum. Water at c.a. 60 mL was added to the wet solid mixture.

After the completion of the water addition, the wet solid was continuously processed in the rotating drum at speed of 100 rpm. The processing time in the rotating drum is 2 hours. Aggregates were dried at ambient temperature and calcined at a temperature of 950° C. for 3 hours. The obtained sorbent is sample No 8-12-M. The one-pot processing granulation produced spherical granules in a broad size range. Granules sieved between 500 to 1190 um corresponded to yield in the range of 40-80%.

### Example 6: Sorbent in Powder

Aluminium nitrate nonahydrate (9.7 g) was divided into added to water (7.5 mL). The mixture were heated in a warm bath at temperature of 95° C. to obtain clear solution. The prepared solution was slowly added to the base material dolomite (fully calcined at 10 g) with stirring. ZrN₂O₇ solution (0.56 g ZrN₂O₇ in 2.4 mL) was added to the mixture with stirring. The amount of added ZrN₂O₇ solution yielded sorbent as product with molar ratio of active CaO/ZrO at 35:1 by which CaO involved in formation of CaZrO₃ with ZrO₂ is not counted as active CaO. The added aluminium nitrate solution yielded sorbent as product with mole ratio of active CaO/Al₂O₃ at 7:1 by which CaO involved in formation of CaAlO₄ with Al₂O₃ is not counted as active CaO. Accordingly, the sorbent has 2 wt % of Zr and 6 wt % of Al ions.

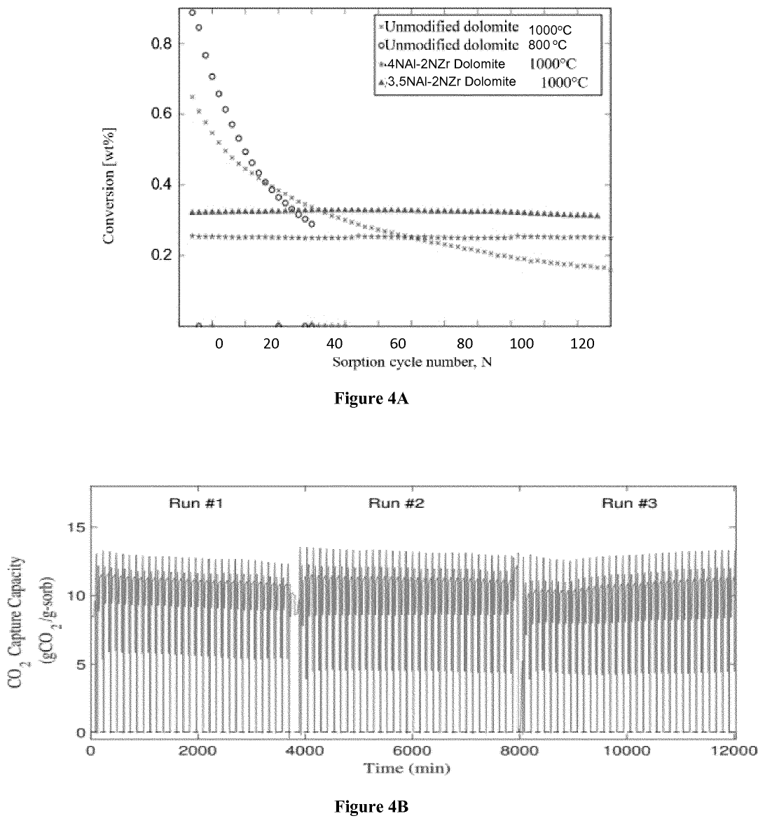

After the addition of the aluminium nitrate and ZrN₂O₇ solution, the mixture were dried at ambient temperature over one week or at 200° C. over 12 hour, followed by calcination at a temperature of 950° C. for 3 hours. The obtained sorbent (4NZr-2NZr dolomite) is loose and porous agglomerates. The agglomerates can be easily milled to fine powder form with average particle size at 50 um, measured by Laser diffraction analysis. 4NZr-2NZr dolomite was tested under the conditions for dry carbon dioxide capture and the results are shown in FIG. 4A.

### Example 7: Calcination

The aggregates prepared from the stepwise wet mixing or one-pot processing needed to be calcined to provide the sorbent capable of carbon dioxide capture. Volatiles are removed during calcination. The calcination temperature and atmosphere are important parameters to affect the properties of the obtained sorbent pellets. As shown in FIG. 4A, two materials containing only dolomite (i.e. not containing any additives) were calcined in static air atmosphere at 800 and 1000° C. respectively. The low calcination temperature yielded sorbent with high initial sorption capacity, but poor stability. The conversion of CaO to calcium carbonate decreases rapidly in the first 40 cycles. By increasing the calcination temperature from 800 to 1000° C., the sorbent's initial conversion dropped, but the stability was much improved.

With appropriate calcination temperature, the sorbent stability can exhibit good stability. The temperature in the present invention can be in the range of 700-1200° C., preferably 850-1100° C.

### Example 8: Long Term Testing

Most of prepared sorbents are tested in desorption-sorption cycles to have the first round evaluation of their capture properties. It is often to observe that the first several cycles indicate great variation of sorption capacity and kinetics. Specially for the purpose of the stability test, a good number of cycles shall be used. More than 40 cycles are operated in the first round material evaluation as a balance of the possible variation trend and time consumption. The number of the cycles is believed to be sufficient to provide reliable information on the stability for the additive composition screening. Some of the sorbents were tested under extended cycles of sorption and desorption to more than 120 cycles.

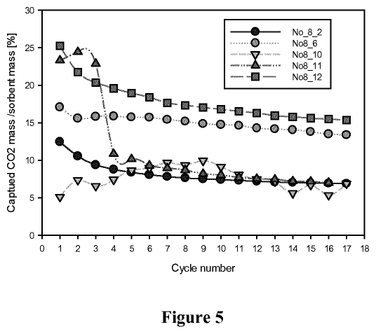

The number of test cycles is realized by the repeating sorption and desorption conditions over desired number of cycles. Sorption conditions in FIG. 4A, FIG. 4B and FIG. 5: 10% CO₂ from 550° C. to 800° C. with ramp at 5° C. min. Desorption conditions: 100% CO₂ from 800 to 950° C. with ramp at 5° C./min and temperature dwells at 950° C. for 10 minutes prior to a new sorption cycle. Sample load is at c.a. 15 mg.

FIG. 4A shows the conversion of the two sorbents (3.5NA1-2NZr and 4NA1-2NZr) as function of the cycle number of sorption-desorption. Unmodified dolomite as benchmark was also tested. 3.5NA1-2NZr and 4NA1-2NZr remained excellent stability over 120 cycles with conversion at c.a. 25% and 30%, respectively.

The sorbent (3.5NA1-2NZr) was further tested with extended cycle numbers. The test was operated in three runs. In each run, low and high sorption peaks occurred 66 times in total. In FIG. 4B, the sorbent exhibited a stable and high capacity at c.a 13% (g_{CO2}/g_{sorbent}) over c.a. 200 cycles of sorption and desorption.

### Example 9: Effect of Starting Materials as Additives

Various additives can be used to prepare the sorbent pellet of the invention. The methods, particularly the one-pot method described above, can make use of additives that are either soluble or insoluble in water.

For instance, the source of aluminium as an additive can be AlCl₃, Al(NO₃)₃ and/or calcium aluminium cement. AlCl₃ or Al(NO₃)₃ are water soluble and can therefore be dissolved in water to obtain clear solution prior to one-pot processing. In contrast, calcium aluminium cement is generally directly mixed with the base material prior to or during one-pot processing. Upon calcination of intermediate pellets, it is believed that volatile components are removed and aluminium ions from AlCl₃ or Al(NO₃)₃ react with calcium oxide in the base material to form calcium aluminium oxide as final stable component in the sorbent pellets.

Various different Al-containing and Zr-containing materials as primary and secondary additives respectively were used to prepare pellets with calcium aluminium oxide and calcium zirconium oxide as final stable components in the sorbent pellets. The preparation techniques are as described in Examples 1 and 3. The applied additives and molar ratios which determine the weight ratio of the base material and additives are presented in Table 2. The calcination temperature was 1000° C. for 3 hours.

TABLE 2
Sorbent pellets prepared with various Al-containing primary and
Zr-containing secondary additives

| | | | | Molar ratio of | |
|---|---|---|---|---|---|
| | | | Weight | active CaO to | |
| | | | load of | dopant metal in | |
| | | | Al/Zr in | sorbent pellet* | |
| Name | Al source | Zr source | sorbent | Al₂O₃ | ZrO₂ |
| No 8-2 | 76% Al from | ZrN₂O₇ | Al (8.3 wt %)- | 5 | 42 |
| | Fondu cement; | (35 wt % | Zr (1.9 wt %) | | |
| | 24% from | aqueous | | | |
| | Al(NO₃)₃ | solution) | | | |
| No 8-6 | Calcium | ZrCl₄ | Al (6.5 wt %)- | 7 | 42 |
| | aluminium | | Zr (1.9 wt %) | | |
| | cement (Fondu) | | | | |
| No 8-10 | AlCl₃ | ZrCl₄ | Al (7.5 wt %)- | 5 | 42 |
| | | | Zr (1.6 wt %) | | |
| No 8-11 | AlCl₃ | ZrN₂O₇ | Al (3.4 wt %)- | 14 | 42 |
| | | (35 wt % | Zr (1.9 wt %) | | |
| | | aqueous | | | |
| | | solution) | | | |
| No 8-12 | Calcium | ZrN₂O₇ | Al (6.5 wt %)- | 7 | 42 |
| | aluminium | (35 wt % | Zr (1.9 wt %) | | |
| | cement (Fondu) | aqueous | | | |
| | | solution) | | | |

*active CaO is referred to the CaO in the base material which is not involved in the reaction with additives and active to carbon dioxide capture to form CaCO₃. For instance, the amount of active CaO in the base material shall be deducted due to formation of CaZrO₃ or CaAl₂O₄ as inert component to carbon dioxide capture.

Carbon dioxide capture properties were evaluated using the dry test conditions described in Example 8.

From FIG. 5, it is found that the capture capacity and stability is dependent on the type of the additives and the ratio of the CaO to dopant metal. A good stability is found on the sorbent pellets with high loading of Al such as No 8-2, No 8-10. However, their capacity is lower than 10% g_{CO2}/g_{sorbent}. The pellet sorbent No 8-11 has similar ratio of active CaO to Al₂O₃ and ZrO₂ ratio to the sample 3.5NA1-2NZr. With fast loss in sorption capacity in the first 5 cycles, No 8-11 remains only c.a. 7% g_{CO2}/g_{sorbent} capacity lower than that observed on 3.5NA1-2NZr. The difference in the two sorbents is the chemical forms of the Al-containing additive. Chloride salt is not as effective to improve the sorbent stability and capacity. No 8-6 and No 8-12 have calcium aluminium cement as Al-containing additive and exhibit the best performance in the dry cyclic carbonation test.

### Example 10: Capture Performance in Cyclic Test with Wet Carbonation

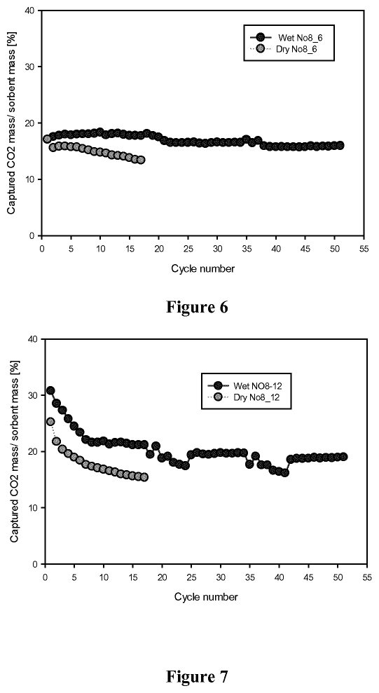

Sorption tests in the presence of steam (ca. 8-10 vol %) were conducted to evaluate the stability of different sorbent pellets. The dry test condition are described in Example 8 and the wet conditions are described in Example 3. Except the steam content, the wet carbonation test uses the same temperature scanning program as cyclic test with dry carbonation. Capture performance of same sorbent can be different under wet and dry sorption conditions. FIGS. 6 and 7 provide a comparison of the results from the dry and wet test on No 8-6 and No 8-12. In general, the two sorbents exhibit higher and more stable capacity in the wet test than in the dry test.

### Example 11: Effect of Additives on Cyclic Performance with Wet Carbonation

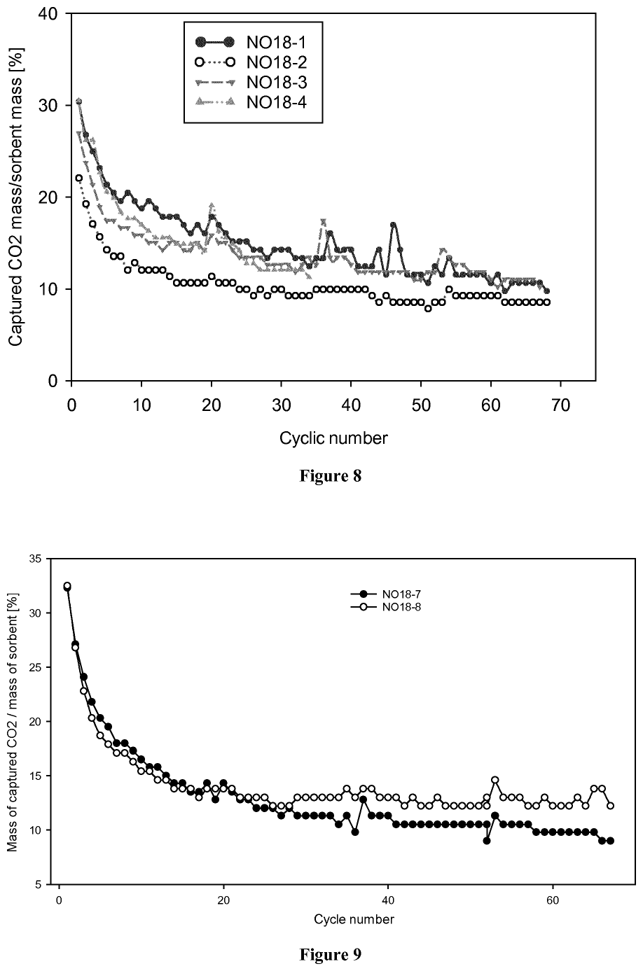

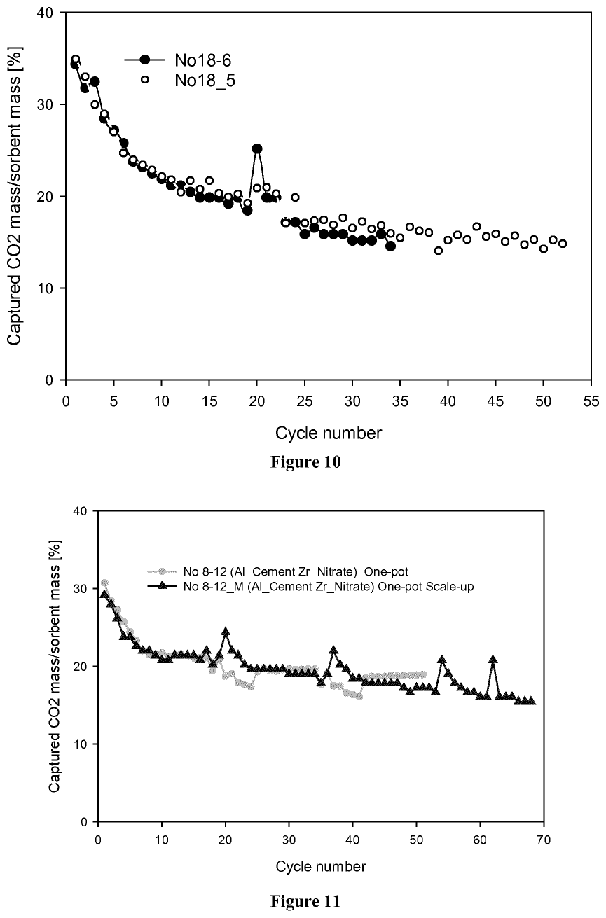

Sorbent pellets were prepared by one-pot processing according to Table 1 and evaluated in the multiple cyclic test with wet carbonation. The results are presented in FIGS. 6 to 10. The best stability and capacity is found on No 18-8 with over 13% (g_{CO2}/g_{sorbent}) after 60 cycles. No 18-8 has Mg nitrate as primary additive and zirconium nitrate as secondary additive. To achieve comparable or high capacity than Mg and Zr containing sorbent, Al and Zr-containing sorbent need high amount of Al loading. That is lower CaO to Al₂O₃ ratio. For instance, No 8-6 and No 8-12 have CaO to Al₂O₃ at c.a 8 and are able to achieve capture capacity at c.a 17% (g_{CO2}/g_{sorbent}) after 50 cycles as shown in FIGS. 6 and 7. The wet conditions are described in Example 3.

### Example 12: Sorbent Pellets Prepared at Different Scales

The sorbent pellets were prepared at different scales. No 8-12 and No 8-12-M have used the same type of the additives and have almost same chemical composition. No 8-12 were prepared by granulation with c.a. 20 gram base material as starting solid material. No 8-12-M was prepared by rotary drum with processing capacity for up to 400 gram of the base material. FIG. 11 shows a comparison of the capture performance of two samples. A quite similar capture capacity is found on the two samples. The one-pot method in the current invention is simple and scalable for preparation of sorbent pellet.

The wet conditions are described in Example 3.

### Example 13: Mechanical Test

A certain level of mechanical strength is generally required for the sorbent material during use. Kinetic energy during impact testing is therefore an important component to validate design criteria. A simple test method of measuring impact force versus displacement, and then integrating for the area under force-displacement curve provides an output in energy units. It is based on the work-energy principle, for a simple drop test, where m=mass, h=drop height, g=acceleration of gravity, and v=velocity at impact, then the conservation of energy equation can be replaced by the following:

mgh=½mv²

The resulting peak acceleration by falling may be calculated from:

a=vᵢₙᵢₜᵢₐₗ−v_{final}=2*√2gh/tₚᵤₗₛₑ

where a=Impact acceleration.
Accordingly, the impact force per mass unit is as the following:

F/m=a=2*√2gh/tₚᵤₗₛₑ=2*√2*4.428*9.8=122.7(N/kg)

The sample drop mass was dropped from 1.5 m with an estimated crumple zone pulse width of 10 msec. The reached peak velocity is at 4,428 m/s. Via Newton's second law force estimation method, this would result in 122.7 N impact force per unit mass, according to the following calculation:

F/m=a=2*√2gh/tₚᵤₗₛₑ=2*√2*4.428*9.8=122.7 (N/kg)

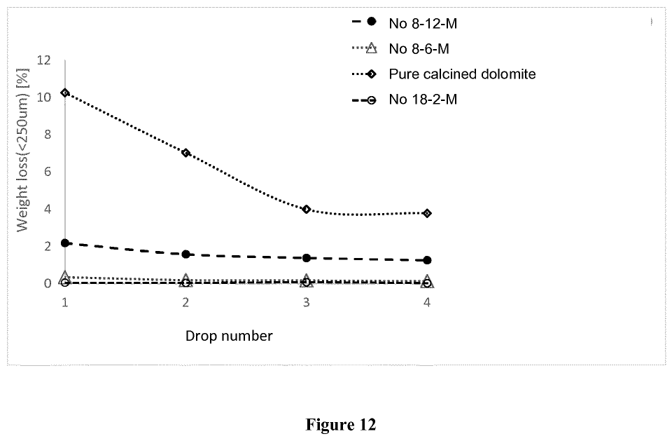

The falling test results were conducted on some of the samples in Table 1 above and results are shown in FIG. 12. All of sample from one-pot processing exhibit much improved mechanical strength than that made of only dolomite. The selected combination of the primary and secondary additives is effective to improve the strength of the sorbent pellet.

1. A method for preparing pellets of sorbent suitable for carbon dioxide capture, the method comprising:
(a) calcining a starting material comprising dolomite to obtain a base material;
(b) mixing the base material with water and additives, wherein the additives comprise a first additive and a second additive, and processing the resulting mixture to provide intermediate pellets; and
(c) calcining the intermediate pellets to provide the pellets of sorbent,
wherein:
the first additive is a source of first metal ions, which first metal ions are ions of Al or Mg, and
the second additive is a source of second metal ions, which second metal ion are ions of Al, Mg, a transition metal or a lanthanide, and
the first and second metal ions are not both ions of Al or both ions of Mg.

2. The method according to claim 1, wherein the calcining in step (a) is carried out at 700 to 1200° C., preferably 800 to 900° C., for 2 to 12 hours.

3. The method according to claim 1 or 2, wherein the base material prepared in step (a) has a surface area of 0.5 to 100 m²/g, preferably 2 to 40 m²/g.

4. The method according to any one of the preceding claims, wherein the starting material of step (a) comprises at least 80 wt % of CaMg(CO₃)₂, preferably at least 90 wt % of CaMg(CO₃)₂.

5. The method according to any one of the preceding claims, wherein the mixing and processing to provide intermediate pellets of step (b) are carried out in the same container, and preferably wherein the mixing and processing to provide intermediate pellets of step (b) occur simultaneously or sequentially, preferably simultaneously.

6. The method according any one of the preceding claims, wherein the mixing and/or processing of step (b) is conducted by one or more of (i) shear force supplied by a manual or motor-driven impellor, (ii) centrifugal force supplied by a rotary container, (iii) extrusion force, and (iv) agitation forced by flowing gas.

7. The method according any one of the preceding claims, wherein the mixing and processing to provide intermediate pellets of step (b) is carried out for 5 minutes to 10 hours, preferably from 20 minutes to 4 hours.

8. The method according to any one of the preceding claims, wherein the intermediate pellets formed in step (b) are substantially spherical, substantially cylindrical or are in honeycomb form and preferably wherein: (i) the pellets are substantially spherical and have diameters ranging from 50 to 6000 μm, preferably from 500 to 3000 μm, (ii) the pellets are substantially cylindrical and have diameters ranging from 500 to 5000 μm, preferably 850 to 3000 μm, or (iii) the pellets are in honeycomb form and have a wall thickness of 500 to 5000 μm, preferably 850 to 3000 μm.

9. The method according to any one of the preceding claims, wherein the first additive is added in step (b) as a solid or dissolved in an aqueous solution, and/or the second additive is added in step (b) as a solid or dissolved in an aqueous solution.

10. The method according to any one of the preceding claims, wherein the source of ions of Al is Al₂O₃, AlCl₃, Al(NO₃)₃, CaAl₂O₄, or a mixture thereof.

11. The method according to any one of the preceding claims, wherein the source of ions of Mg is MgO, Mg(NO₃)₂, MgCl₂ or mixtures thereof.

12. The method according to any one of the preceding claims, wherein the transition metal is Zr, and preferably wherein the source of ions of Zr is ZrO₂, ZrCl₄, ZrN₂O₇ or a mixture thereof.

13. The method according to any one of the preceding claims, wherein the lanthanide is Ce, and preferably wherein the source of ions of Ce is Ce₂O₃, Ce(NO₃)₃, CeCl₃ or mixtures thereof.

14. The method according to any one of the preceding claims, wherein: (i) the first additive is a source of ions of Al and the second additive is a source of ions of Mg, (ii) the first additive is a source of ions of Al and the second additive is a source of ions of Zr, (iii) the first additive is a source of ions of Al and the second additive is a source of ions of Ce, (iv) the first additive is a source of ions of Mg and the second additive is a source of ions of Al, (v) the first additive is a source of ions of Mg and the second additive is a source of ions of Zr, or (vi) the first additive is a source of ions of Mg and the second additive is a source of ions of Ce.

15. The method according to any one of the preceding claims, wherein one or more further additives are mixed with the base material, water, first additive and second additive in step (b), and preferably wherein (i) the one or more further additives are selected from sources of metal ions other than the first metal ions and the second metal ions, or (ii) the one or more further additives do not contain metal ions.

16. The method according to any one of the preceding claims, wherein:
(i) the intermediate pellets from step (b) are used directly in step (c) without any intervening processing, or
(ii) the intermediate pellets from step (b) are subjected to intervening processing, such as sieving and/or spheronization, prior to step (c).

17. The method according to any one of the preceding claims, wherein the calcining in step (c) is carried out at 700 to 1200° C., preferable 800 to 1000° C., for 2 to 12 hours.

18. The method according to any one of the preceding claims, wherein (a) 0.5 to 20 wt %, preferably 2 to 10 wt %, of the pellets of sorbent is the first metal ions, and/or (b) 0.5 to 10 wt %, preferably 0.5 to 6 wt %, of the pellets of sorbent is the second metal ions.

19. The method according to any one of the preceding claims, wherein the molar ratio of first metal ions to second metal ions in the pellets of sorbent is from 20 to 1, preferably from 10 to 2.

20. Pellets of sorbent suitable for carbon dioxide capture, which pellets are obtainable by a method as defined in any one of the preceding claims.

21. A sorbent suitable for carbon dioxide capture, which sorbent comprise CaO, MgO, 0.5 to 20 wt % of first metal ions and 0.5 to 10 wt % of second metal ions, wherein the first metal and second metal ions are as defined in any one of claims 1 and 12 to 14, and wherein the sorbent is in the form of pellets.

22. A method for carbon dioxide capture, which method comprises exposing sorbent as defined in claim 20 or 21 to carbon dioxide under conditions suitable for carbon dioxide capture, thereby providing a carbonated sorbent comprising the captured carbon dioxide.

23. The method according to claim 22, which further comprises regenerating the sorbent as defined in claim 20 or 21 by calcining the carbonated sorbent.

24. A carbonated sorbent comprising carbonated CaO, MgO, 0.4 to 20 wt % of first metal ions and 0.4 to 10 wt % of second metal ions, wherein the first metal and second metal ions are as defined in any one of claims 1 and 12 to 14, and wherein the carbonated sorbent is in the form of pellets.

25. Use of sorbent as defined in claims 20 to 21, for:
carbon dioxide capture, preferably (a) post-combustion carbon dioxide capture, or (b) pre-combustion carbon dioxide capture from a H₂ and CO₂-rich gas mixture; or
capture of sulfur-containing compounds, preferably capture of SO₂ and/or H₂S, from sour gas.
